(19) United States
(12) Patent Application Publication
(10) Pub. No.: US 2008/0078094 A1
(43) Pub. Date: Apr. 3, 2008

(54) Graphing template

(76) Inventor: Frank Baumann, Waikiki, HI (US)

Correspondence Address: GOLDIZEN & Associates, One Columbus Center, Ste. 665, VIRGINIA BEACH, VA, 23462, US

(21) Appl. No.: 11/540,057

(22) Filed: Sep. 29, 2006

(51) Int. Cl. B43L 7/00

(52) U.S. Cl. 33/566

(57) ABSTRACT

A graphing template includes a substantially square shaped, rigid piece of planar material. The planar material includes two elongated openings extending through the planar material and intersecting to form an origin and define four quadrants. The elongated openings are sufficiently large to accommodate a tip of a writing instrument such that a two dimensional graph may be generated by depositing the template onto a writing surface and thereafter inserting the tip of the writing instrument into the elongated openings and marking upon the writing surface to form an “x” axis and a “y” axis. The planar material includes an array of circularly-shaped holes located equidistance from one another in each quadrant and extending through the planar material. These circularly-shaped holes are arranged in equidistance rows and columns and are positioned in groups in the four quadrants. The planar material also comprises four straight outer edges, where at least one outer edge of the plane plate is comprised of ruler markings.

There are no related patent applications.

This application did not receive federal research and development funding.

### BACKGROUND OF THE INVENTION

The present invention generally relates to a graphing template. More particularly, the invention relates to a graphing template that can assist a user in neatly plotting points and drawing straight lines on a graph.

There are many types of graphing and sketching templates commercially available which assist a user in tracing shapes or drawing straight lines. Most of these templates are directed towards use by engineers and architects. However, there are no graphing templates available that actually provide a template for the user to plot points on a graph, while also assisting the user in connecting the plotted points by drawing a straight line between a pair of plotted points. The present invention combines both elements to allow the user to neatly perform both of these functions with ease when graphing, while also appealing to a much broader consumer base.

### BRIEF SUMMARY OF THE INVENTION

The invention, a graphing template, is a new type of graphing template that utilizes a rigid, removable template to assist a user in plotting points and drawing lines on a line graph having two axis.

An object of the invention is to enable the user to plot points and draw straight lines on a graph quickly, more easily, and more accurately than if done by hand alone.

Another object of the invention is to provide a template that is easily usable to create a line graph.

The invention may be manufactured in a variety of materials, including, but not limited to, plastic, wood, and metal.

The invention comprises a square plate with two elongated openings that are perpendicular and intersect in the center of the plate to form a cross, or “t,” shape. The intersection of the elongated openings forms an origin and defines four quadrants. The openings are large enough that a tip of a writing end of a writing instrument, such as a pencil or pen may be inserted through them, so that the cross shaped may be traced onto an underlying piece of paper. The invention also comprises an array of holes that extend through the plate, and are arranged at equal space in both rows and columns respectively extending along horizontal and vertical coordinates in the four quadrants. That is, the holes that are provided in each quadrant are equidistance from one another. These holes are positioned in groups in the four quadrants that are created by the perpendicular cross-shaped openings in the center of the plane plate. The outside edges of the plate consist of straight edges, with at least one side of the plate having ruler markings for performing measurements.

A user places the invention on top of a piece of paper. The user then traces the perpendicular cross shape onto the underlying paper by inserting a pencil through the hole and tracing out the shape. Next, the user plots points onto the underlying paper by inserting a pencil into the chosen holes on the template and depositing an ink spot on the paper, where the ink spot represents a point plotted on the line graph. The user then moves the template so that the straight edge of the plate sits atop the plotted points on the paper. The edge is then used as a guide to connect the points by tracing a straight line along the edge of the template to create a neat linear graph of the plotted points.

### BRIEF DESCRIPTION OF THE DRAWINGS

FIG. 1 is an overhead plan view of the graphing template.

FIG. 2 is a perspective view of the template shown in FIG. 1.

FIG. 3 is a plan view of a first step in a process for using the template.

FIG. 4 is an overhead view showing the template in use.

FIG. 5 shows an overhead view of the template showing one of the straight edges being used to provide assistance drawing a straight line between two points.

FIG. 6 shows a completed line graph with a series of plotted points that are connected to form a straight line.

FIG. 7 depicts an embodiment of the invention that comprises a plurality of only a series of rows and columns and without an opening that creates an origin a graphing template.

FIG. 8 includes an embodiment of the invention that includes an elongated series of columns that exceeds the number of rows of the graphing template.

### DETAILED DESCRIPTION OF THE INVENTION

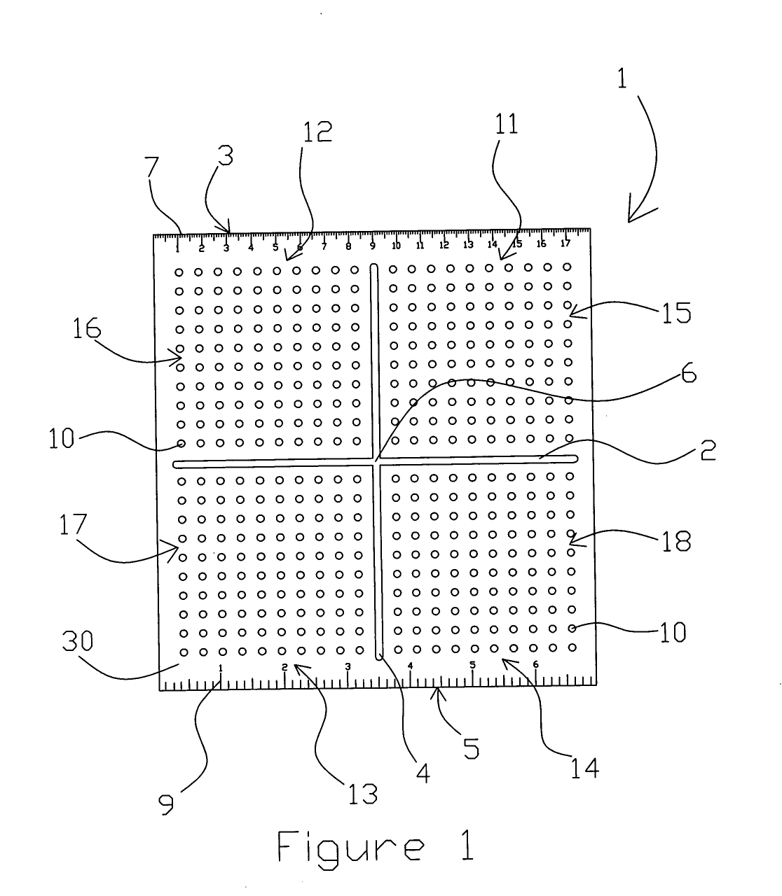

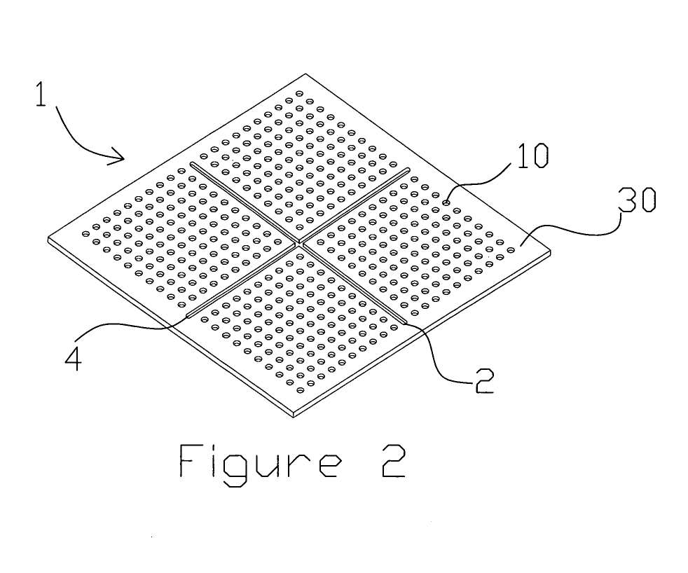

FIG. 1 depicts an embodiment of the template 1 and showing the various features. The template 1 comprises template material 30 and includes at least a pair of straight edges 3, 5. The straight edge 3 includes graduated marks 7 that represent metric units of measure. In the present embodiment, the graduated marks 7 are represented in centimeters and millimeters. The straight edge 5 includes graduated marks that represent English units of measure 9 which are represented by inches and fractions thereof.

Two elongated openings 2, 4 intersect in a perpendicular fashion to create origin 6 which corresponds to an origin on a line graph that is produced by the instant template 1. The elongated openings 2, 4 extend from near one edge of the template 1 to an opposite end, as shown. These elongated openings are sufficiently wide to accept an end of a writing device such that axis lines for a line graph may be produced by inserting the end of the writing device 50 into the elongated openings and sliding the writing device from one end of an elongated opening to an opposite end to trace a straight line onto a paper 20 onto which the template 1 is placed. Typically, the template 1 comprises a plastic, wood or other material that is rigid in nature.

The elongated openings 2, 4 divide the template 1 into four quadrants 11, 12, 13, 14. The elongated openings intersect at right angles to one another to produce an origin 6. Each quadrant includes a plurality of openings 15, 16, 17, 18 provided in line and columnar form. The distance between each opening 10 is preferably uniform in each quadrant. In quadrant 11, the distance between each opening is equal. However, in quadrant 12, the distance between each opening may be different that that of quadrant 11, whilst the distance between holes in quadrant 12 may be uniform. For example, the distance between holes in quadrant 11 may be 2 cm; whilst the distance between holes in quadrant 12 may be 0.5 inches. By varying the distance between the holes of the various quadrants, the template may be used to produce graphs of various sizes. However, the distance between holes in each quadrant is uniform within the quadrant. The size of all the circular holes 10 are the same.

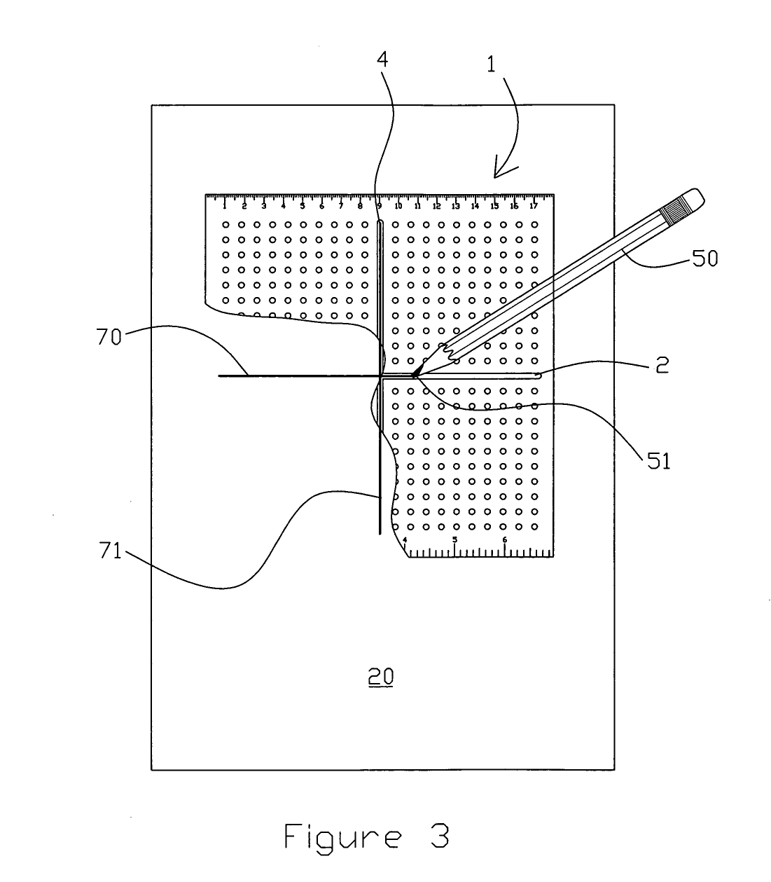

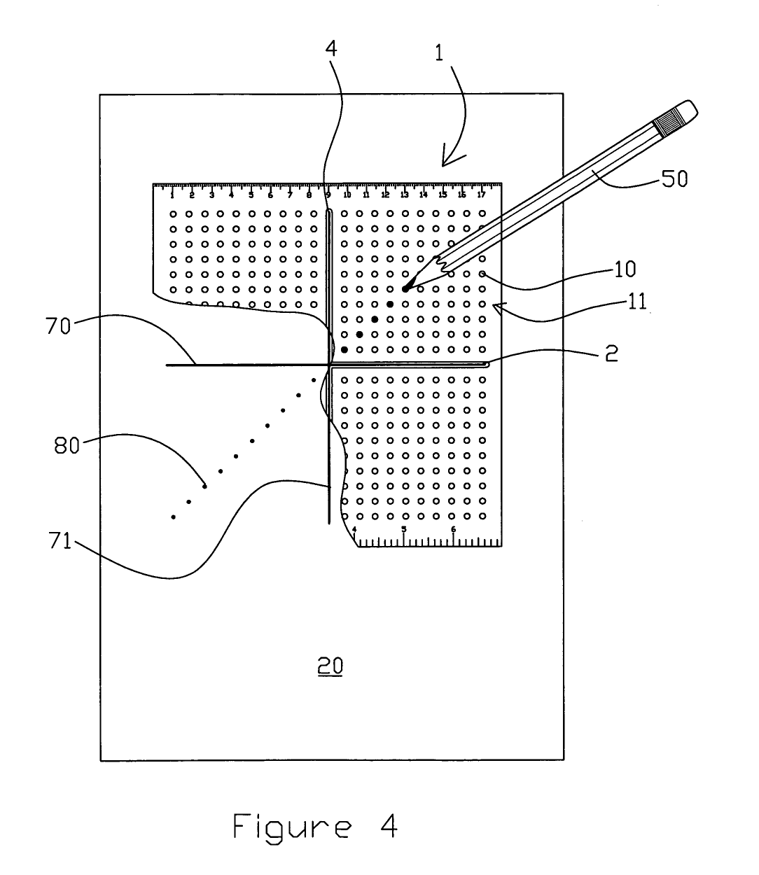

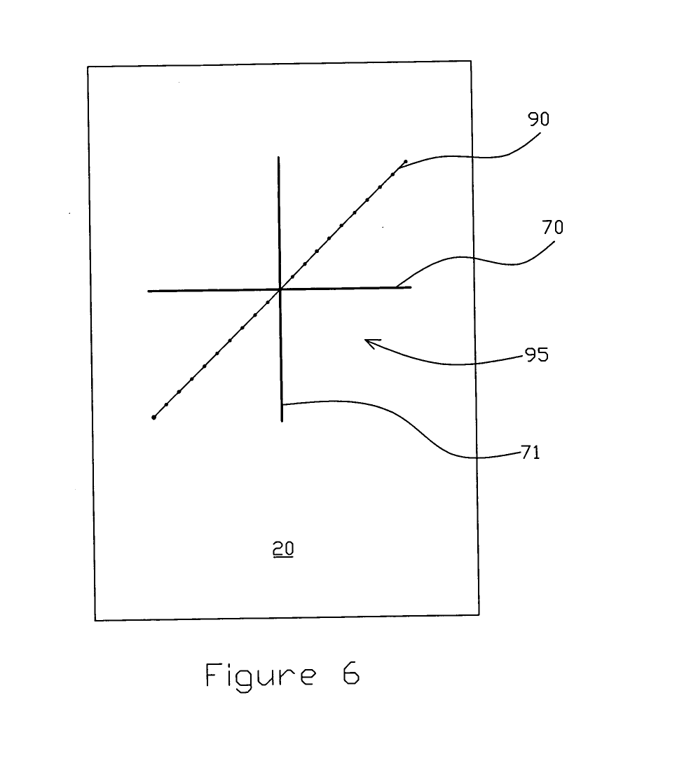

FIGS. 3 through 5 show how the template 1 is used to produce a line graph 100, as shown in FIG. 6. As shown in FIG. 3, the template 1 is deposited onto a sheet of paper 20. A tip 51 of a writing instrument 50 extends through elongated openings 2, 4 and an “x” axis 70 and a “y” axis 71 is traced onto the paper 20.

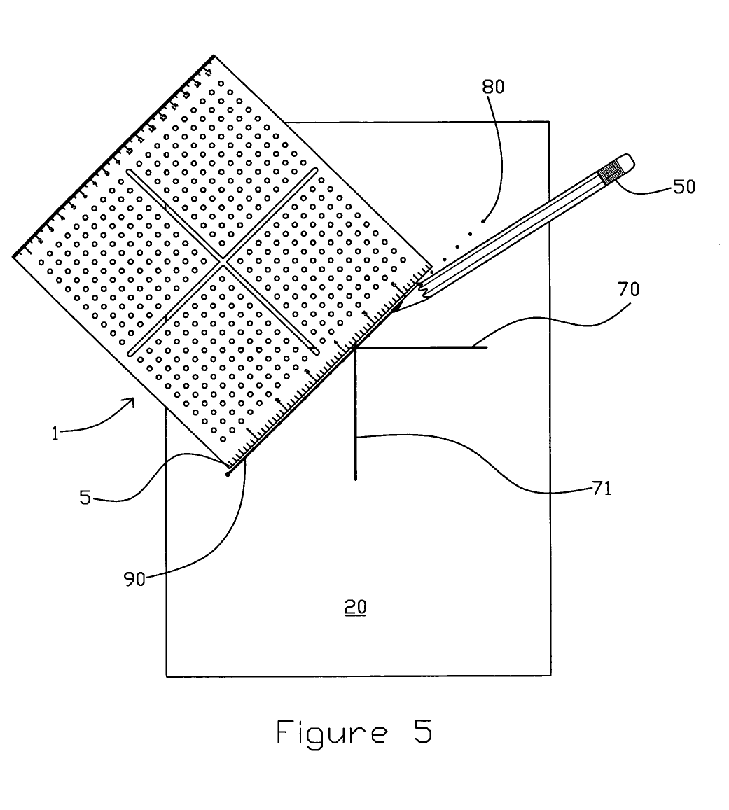

Next, the user plots points 80 onto the paper 20 at desired locations. In this example, the holes 10 in quadrant 11 are selected as the preferred distances for plotting the points 80. As shown in FIG. 5, the straight edge 5 is aligned along the plotted points 80 and a line 90 is drawn and which connects the plotted points 80 together.

As shown in FIG. 6, a line graph 95 that comprises “x” axis 70 and “y” axis 71 and having a plotted set of points that comprise line 90 is created through use of the template 1.

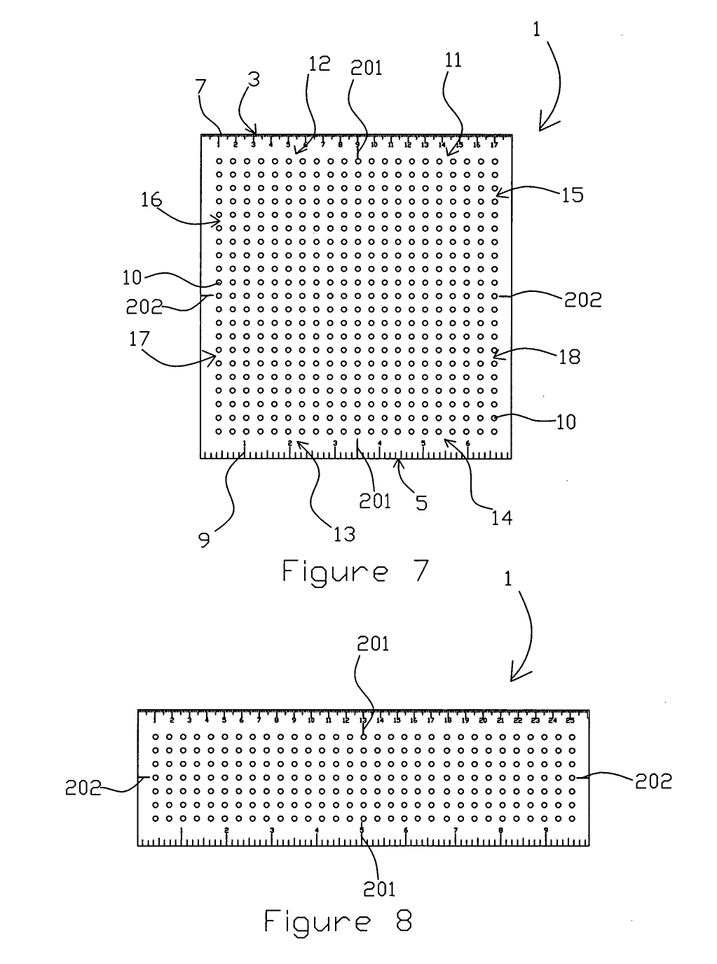

FIG. 7 depicts an alternative embodiment of the invention wherein only a plurality of circular through holes are arranged in the template material. In this embodiment, the number of rows of holes and the number of columns of holes are odd number integers. A central vertical line 201 is displayed on both upper and lower ends of the template material to indicate a plurality of holes that divide the template into separate quadrants. Likewise, a central horizontal line 202 is included on opposite sides of the template material as shown and separate the upper and lower hemispheres. In this manner, both of these central lines extend through the origin of graphing template.

FIG. 8 is an elongated version of the present invention wherein the total number of rows of holes are less than the columns of holes formed in the template material. Central marks 201, 202 are provided on left to right and top to bottom sides of the template material as shown.

While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. A graphing template for creating a line graph comprising an x-axis and a y-axis that define four quadrants for plotting points that represent a relationship between at least two variables, said graphing template comprising:
a piece of template material having a center and including at least two straight edges having graduation marks displayed thereon;
a first elongated opening passing through the center of the template material;
a second elongated opening passing through the center of the template material to perpendicularly intersect the first elongated opening to create four quadrants, said first and second elongated openings creating a large opening through which the line graph having an origin located at a point where the first elongated opening intersects the second elongated opening, wherein the graph for displaying a relationship between at least two variables may be created by passing an end of a writing instrument through both the first or second elongated openings and tracing a shape of both the first and second elongated openings onto an underlying piece of paper; and
a plurality of circular openings arranged on opposite sides of each elongated opening such that the end of the writing instrument may be passed therethrough to plot points on the line graph at desired locations.

2. The graphing template of claim 1 wherein the circular openings arranged in each quadrant are equidistantly spaced from one another.

3. The graphing template of claim 1 wherein the graduation marks displayed on one of the straight edges is metric measurements.

4. The graphing template of claim 1 wherein the graduation marks displayed on one of the straight edges are English measurements expressed in inches or fractions of inches.

5. The graphing template of claim 1 wherein said piece of template material comprises plastic.

6. The graphing template of claim 1 wherein said piece of template material comprises wood.

7. The graphing template of claim 1 wherein said piece of template material comprises metal.

8. A method for creating a line graph having an x-axis and a y-axis which intersect one another to create an origin:
providing a piece of paper onto which the line graph is traced;
providing a piece of template material having a center and including at least two straight edges having graduation marks displayed thereon, said template material further including a first elongated opening passing through the center of the template material and a second elongated opening passing through the center of the template material to perpendicularly intersect the first elongated opening to create four quadrants;
passing a writing end of a writing instrument through the first and second elongated openings;
tracing a pair of perpendicular lines onto the piece of paper to create the line graph;
plotting points that define a relationship between two variables;

9. The method of claim 8 further comprising placing one of said template material on said paper such that one of said straight edges extends between a first plotted point and a second plotted point to provide a template for drawing a straight line between the first and second plotted points by first placing the writing end of the writing instrument against said one of said straight edges and moving the writing instrument to cause a line to be drawn between the first and second plotted points.

10. The method of claim 8 wherein the step of providing a template material includes providing a template material that comprises a plurality of equidistant holes in at least one of said quadrants; and,
the step of plotting points further includes passing a tip of a writing end of the writing instrument through one of said equidistant holes to create an ink spot on the paper that represents a point on the line graph.

11. A graphing template for creating a line graph comprising an x-axis and a y-axis that define four quadrants for plotting points that represent a relationship between at least two variables, said graphing template comprising:
a piece of template material having a center and including at least two straight edges having graduation marks displayed thereon; and, a plurality of circular openings that extend from a first side of the template material to a second side of the template material, said plurality of circular openings having a diameter large enough such that an end of a writing instrument may be passed therethrough to plot points on the line graph at desired locations.

12. The graphing template of claim 11 wherein a total number of columns of holes exceeds a total number of rows of holes in the graphing template.
